(19) United States
(12) Patent Application Publication
(10) Pub. No.: US 2026/0333364 A1
(43) Pub. Date: Oct. 22, 2026

(54) DEVICES, METHODS, APPARATUSES, AND COMPUTER READABLE MEDIA FOR CONFIGURED GRANT ACTIVATION

(71) Applicant: Nokia Technologies Oy, Espoo (FI)

(72) Inventors: Jarkko Tuomo KOSKELA, Oulu (FI); Daniela LASELVA, Aalborg (DK); Chunli WU, Beijing (CN); Jorma Johannes KAIKKONEN, Oulu (FI)

(21) Appl. No.: 19/099,637

(22) PCT Filed: Aug. 9, 2022
(86) PCT No.: PCT/CN2022/111126

§ 371 Date: Jan. 29, 2025

(51) Int. Cl. H04W 72/23; H04W 28/02

(52) U.S. Cl. CPC H04W 72/23; H04W 28/0221; H04W 28/0278

(57) ABSTRACT

Disclosed are devices, methods, apparatuses, and computer readable media for configured grant activation. An example terminal device may include at least one processor and at least one memory. The at least one memory may store instructions that, when executed by the at least one processor, may cause the terminal device at least to perform: receiving from a network device, configuration information of a configured grant resource; determining to activate the configured grant resource; and performing a transmission to the network device using the activated configured grant resource.

### TECHNICAL FIELD

Various embodiments relate to devices, methods, apparatuses, and computer readable media for configured grant (CG) activation.

### BACKGROUND

Currently, activation and deactivation of a CG resource, e.g. CG-physical uplink shared channel (PUSCH) resource(s) may be controlled by network side. There have been two types of CG resources. For CG Type-1, configuration and de-configuration of the CG resource may be provided by the network side via radio resource control (RRC) signaling without physical downlink control channel (PDCCH) activation and deactivation. For CG Type-2, the configuration and de-configuration of the CG resource may be provided via RRC whereas the activation and deactivation for the CG with physical resource block (PRB) resource, modulation and coding scheme (MCS) etc. may be provided via PDCCH addressed to configured scheduling radio network temporary identifier (CS-RNTI). However, the network side usually has limited visibility on data in user equipment (UE) buffer, which is based primarily on the received buffer status report (BSR), and therefore it may be challenging for the network side to determine whether and/or when the deactivation is suitable or whether the deactivation may cause latency penalties for the UE. CG based operation(s) is/are defined mainly for deterministic and regular traffic types, however, real life traffic may not be so regular in practice due to application behavior and jitter. For such reason, the UE may skip a CG-PUSCH occasion if no data is present. However, the network side is unaware of such skipping, and therefore it would nevertheless need to perform reception monitoring unnecessarily.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: receiving from a network device, configuration information of a configured grant resource; determining to activate the configured grant resource; and performing a transmission to the network device using the activated configured grant resource.

In some example embodiments, at least one occasion for using the configured grant resource may be determined to be activated.

In some example embodiments, the instructions, when executed by the at least one processor, may cause the terminal device to further perform: stopping the transmission to the network device using the activated configured grant resource in case of receiving from the network device, a signaling deactivating the configured grant resource.

In some example embodiments, in a case where a first response confirming the activation is required for the transmission using the configured grant resource after first one or more occasions, the transmission after the first one or more occasions may be performed after receiving the first response.

In some example embodiments, the instructions, when executed by the at least one processor, may cause the terminal device to further perform: transmitting to the network device, an indication indicative of activating the configured grant resource;

In some example embodiments, the transmission to the network device may be performed after receiving a second response to the indication, the second response confirming the activation.

In some example embodiments, the indication may indicate an uplink buffer status.

In some example embodiments, the transmission to the network device may be performed after an activation delay period starting from transmitting the indication.

In some example embodiments, the configuration information may comprise the activation delay period.

In some example embodiments, the activation delay period may be determined by the terminal device based on a predefined condition.

In some example embodiments, the predefined condition may be associated with periodicity of at least one of the following: a synchronization signal block or a reference signal.

In some example embodiments, an initial occasion for the transmission using the configured grant resource may be after the activation delay period.

In some example embodiments, the indication may be transmitted via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In some example embodiments, the configured grant resource may be determined to be activated in a case of reporting a non-empty buffer status report.

In a second aspect, disclosed is a network device. The network device may include at least one processor and at least one memory. The at least one memory may store instructions that, when executed by the at least one processor, may cause the network device at least to perform: transmitting to a terminal device, configuration information of a configured grant resource; and receiving a transmission from the terminal device on the activated configured grant resource.

In some example embodiments, the instructions, when executed by the at least one processor, may cause the network device to further perform: transmitting to the terminal device, a signaling deactivating the configured grant resource.

In some example embodiments, in a case where a first response confirming the activation is required for the transmission using the configured grant resource after first one or more occasions, the instructions, when executed by the at least one processor, may cause the network device to further perform: transmitting to the terminal device, the first response in case of confirming the activation.

In some example embodiments, the instructions, when executed by the at least one processor, may cause the network device to further perform: receiving from the terminal device, an indication indicative of activating the configured grant resource;

In some example embodiments, the instructions, when executed by the at least one processor, may cause the network device to further perform: initiating reception monitoring for the activated configured grant resource after transiting out of a sleep mode or after receiving the indication.

In some example embodiments, the instructions, when executed by the at least one processor, may cause the network device to further perform: transmitting to the terminal device, a second response to the indication for confirming the activation, in case of confirming the activation; and initiating reception monitoring for the activated configured grant resource upon transmitting the second response.

In some example embodiments, the indication may indicate an uplink buffer status.

In some example embodiments, the configuration information may comprise an activation delay period starting from transmitting the indication, after which the transmission on the activated configured grant resource is allowed.

In some example embodiments, the instructions, when executed by the at least one processor, may cause the network device to further perform: transiting out of a sleep mode upon receiving the indication.

In some example embodiments, the indication may be received via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In a third aspect, disclosed is a method performed by a terminal device. The method may comprise: receiving from a network device, configuration information of a configured grant resource; determining to activate the configured grant resource; and performing a transmission to the network device using the activated configured grant resource.

In some example embodiments, at least one occasion for using the configured grant resource may be determined to be activated.

In some example embodiments, the method may further comprise: stopping the transmission to the network device using the activated configured grant resource in case of receiving from the network device, a signaling deactivating the configured grant resource.

In some example embodiments, in a case where a first response confirming the activation is required for the transmission using the configured grant resource after first one or more occasions, the transmission after the first one or more occasions may be performed after receiving the first response.

In some example embodiments, the method may further comprise: transmitting to the network device, an indication indicative of activating the configured grant resource;

In some example embodiments, the transmission to the network device may be performed after receiving a second response to the indication, the second response confirming the activation.

In some example embodiments, the indication may indicate an uplink buffer status.

In some example embodiments, the transmission to the network device may be performed after an activation delay period starting from transmitting the indication.

In some example embodiments, the configuration information may comprise the activation delay period.

In some example embodiments, the activation delay period may be determined by the terminal device based on a predefined condition.

In some example embodiments, the predefined condition may be associated with periodicity of at least one of the following: a synchronization signal block or a reference signal.

In some example embodiments, an initial occasion for the transmission using the configured grant resource may be after the activation delay period.

In some example embodiments, the indication may be transmitted via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In some example embodiments, the configured grant resource may be determined to be activated in a case of reporting a non-empty buffer status report.

In a fourth aspect, disclosed is a method performed by a network device. The method may comprise: transmitting to a terminal device, configuration information of a configured grant resource; and receiving a transmission from the terminal device on the activated configured grant resource.

In some example embodiments, the method may further comprise: transmitting to the terminal device, a signaling deactivating the configured grant resource.

In some example embodiments, in a case where a first response confirming the activation is required for the transmission using the configured grant resource after first one or more occasions, the method may further comprise: transmitting to the terminal device, the first response in case of confirming the activation.

In some example embodiments, the method may further comprise: receiving from the terminal device, an indication indicative of activating the configured grant resource;

In some example embodiments, the method may further comprise: initiating reception monitoring for the activated configured grant resource after transiting out of a sleep mode or after receiving the indication.

In some example embodiments, the method may further comprise: transmitting to the terminal device, a second response to the indication for confirming the activation, in case of confirming the activation; and initiating reception monitoring for the activated configured grant resource upon transmitting the second response.

In some example embodiments, the indication may indicate an uplink buffer status.

In some example embodiments, the configuration information may comprise an activation delay period starting from transmitting the indication, after which the transmission on the activated configured grant resource is allowed.

In some example embodiments, the method may further comprise: transiting out of a sleep mode upon receiving the indication.

In some example embodiments, the indication may be received via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In a fifth aspect, disclosed is an apparatus. The apparatus as a terminal device may comprise: means for receiving from a network device, configuration information of a configured grant resource; means for determining to activate the configured grant resource; and means for performing a transmission to the network device using the activated configured grant resource.

In some example embodiments, at least one occasion for using the configured grant resource may be determined to be activated.

In some example embodiments, the apparatus may further comprise: means for stopping the transmission to the network device using the activated configured grant resource in case of receiving from the network device, a signaling deactivating the configured grant resource.

In some example embodiments, in a case where a first response confirming the activation is required for the transmission using the configured grant resource after first one or more occasions, the transmission after the first one or more occasions may be performed after receiving the first response.

In some example embodiments, the apparatus may further comprise: means for transmitting to the network device, an indication indicative of activating the configured grant resource;

In some example embodiments, the transmission to the network device may be performed after receiving a second response to the indication, the second response confirming the activation.

In some example embodiments, the indication may indicate an uplink buffer status.

In some example embodiments, the transmission to the network device may be performed after an activation delay period starting from transmitting the indication.

In some example embodiments, the configuration information may comprise the activation delay period.

In some example embodiments, the activation delay period may be determined by the terminal device based on a predefined condition.

In some example embodiments, the predefined condition may be associated with periodicity of at least one of the following: a synchronization signal block or a reference signal.

In some example embodiments, an initial occasion for the transmission using the configured grant resource may be after the activation delay period.

In some example embodiments, the indication may be transmitted via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In some example embodiments, the configured grant resource may be determined to be activated in a case of reporting a non-empty buffer status report.

In a sixth aspect, disclosed is an apparatus. The apparatus as a network device may comprise: means for transmitting to a terminal device, configuration information of a configured grant resource; and means for receiving a transmission from the terminal device on the activated configured grant resource.

In some example embodiments, the apparatus may further comprise: means for transmitting to the terminal device, a signaling deactivating the configured grant resource.

In some example embodiments, in a case where a first response confirming the activation is required for the transmission using the configured grant resource after first one or more occasions, the apparatus may further comprise: means for transmitting to the terminal device, the first response in case of confirming the activation.

In some example embodiments, the apparatus may further comprise: means for receiving from the terminal device, an indication indicative of activating the configured grant resource;

In some example embodiments, the apparatus may further comprise: means for initiating reception monitoring for the activated configured grant resource after transiting out of a sleep mode or after receiving the indication.

In some example embodiments, the apparatus may further comprise: means for transmitting to the terminal device, a second response to the indication for confirming the activation, in case of confirming the activation; and means for initiating reception monitoring for the activated configured grant resource upon transmitting the second response.

In some example embodiments, the indication may indicate an uplink buffer status.

In some example embodiments, the configuration information may comprise an activation delay period starting from transmitting the indication, after which the transmission on the activated configured grant resource is allowed.

In some example embodiments, the apparatus may further comprise: means for transiting out of a sleep mode upon receiving the indication.

In some example embodiments, the indication may be received via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In a seventh aspect, a computer readable medium is disclosed. The computer readable medium may comprise program instructions that, when executed by a terminal device, may cause the terminal device at least to perform: receiving from a network device, configuration information of a configured grant resource; determining to activate the configured grant resource; and performing a transmission to the network device using the activated configured grant resource.

In some example embodiments, at least one occasion for using the configured grant resource may be determined to be activated.

In some example embodiments, the computer readable medium may further comprise instructions that, when executed by the terminal device, may cause the terminal device to further perform: stopping the transmission to the network device using the activated configured grant resource in case of receiving from the network device, a signaling deactivating the configured grant resource.

In some example embodiments, in a case where a first response confirming the activation is required for the transmission using the configured grant resource after first one or more occasions, the transmission after the first one or more occasions may be performed after receiving the first response.

In some example embodiments, the computer readable medium may further comprise instructions that, when executed by the terminal device, may cause the terminal device to further perform: transmitting to the network device, an indication indicative of activating the configured grant resource;

In some example embodiments, the transmission to the network device may be performed after receiving a second response to the indication, the second response confirming the activation.

In some example embodiments, the indication may indicate an uplink buffer status.

In some example embodiments, the transmission to the network device may be performed after an activation delay period starting from transmitting the indication.

In some example embodiments, the configuration information may comprise the activation delay period.

In some example embodiments, the activation delay period may be determined by the terminal device based on a predefined condition.

In some example embodiments, the predefined condition may be associated with periodicity of at least one of the following: a synchronization signal block or a reference signal.

In some example embodiments, an initial occasion for the transmission using the configured grant resource may be after the activation delay period.

In some example embodiments, the indication may be transmitted via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

In some example embodiments, the configured grant resource may be determined to be activated in a case of reporting a non-empty buffer status report.

In an eighth aspect, a computer readable medium is disclosed. The computer readable medium may comprise program instructions that, when executed by a network device, cause the network device at least to perform: transmitting to a terminal device, configuration information of a configured grant resource; and receiving a transmission from the terminal device on the activated configured grant resource.

In some example embodiments, the computer readable medium may further comprise instructions that, when executed by the network device, may cause the network device to further perform: transmitting to the terminal device, a signaling deactivating the configured grant resource.

In some example embodiments, in a case where a first response confirming the activation is required for the transmission using the configured grant resource after first one or more occasions, the computer readable medium may further comprise instructions that, when executed by the network device, may cause the network device to further perform: transmitting to the terminal device, the first response in case of confirming the activation.

In some example embodiments, the computer readable medium may further comprise instructions that, when executed by the network device, may cause the network device to further perform: receiving from the terminal device, an indication indicative of activating the configured grant resource;

In some example embodiments, the computer readable medium may further comprise instructions that, when executed by the network device, may cause the network device to further perform: initiating reception monitoring for the activated configured grant resource after transiting out of a sleep mode or after receiving the indication.

In some example embodiments, the computer readable medium may further comprise instructions that, when executed by the network device, may cause the network device to further perform: transmitting to the terminal device, a second response to the indication for confirming the activation, in case of confirming the activation; and initiating reception monitoring for the activated configured grant resource upon transmitting the second response.

In some example embodiments, the indication may indicate an uplink buffer status.

In some example embodiments, the configuration information may comprise an activation delay period starting from transmitting the indication, after which the transmission on the activated configured grant resource is allowed.

In some example embodiments, the computer readable medium may further comprise instructions that, when executed by the network device, may cause the network device to further perform: transiting out of a sleep mode upon receiving the indication.

In some example embodiments, the indication may be received via at least one of the following: a dedicated scheduling request, a dedicated random access preamble, dedicated uplink control information, or a physical uplink shared channel.

In some example embodiments, the physical uplink shared channel may be a configured grant physical uplink shared channel with periodicity longer than that of the configured grant resource.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows exemplary sequence diagram for CG activation according to various example embodiments of the present disclosure.

FIG. 2 shows exemplary sequence diagram for CG activation according to various example embodiments of the present disclosure.

FIG. 3 shows exemplary sequence diagram for CG activation according to various example embodiments of the present disclosure.

FIG. 4 shows a flow chart illustrating an example method 400 for CG activation according to the example embodiments of the present disclosure.

FIG. 5 shows a flow chart illustrating an example method 500 for CG activation according to the example embodiments of the present disclosure.

FIG. 6 shows a block diagram illustrating an example device 600 for CG activation according to the example embodiments of the present disclosure.

FIG. 7 shows a block diagram illustrating an example device 700 for CG activation according to the example embodiments of the present disclosure.

FIG. 8 shows a block diagram illustrating an example apparatus 800 for CG activation according to the example embodiments of the present disclosure.

FIG. 9 shows a block diagram illustrating an example apparatus 900 for CG activation according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for CG activation. According to the example embodiments of the present disclosure, a type of CG resource may be activated by the UE. The network side may increase reception monitoring upon presence of uplink data or receiving an indication from the UE, which allows to keep a low level of reception at the network side, thus saving energy at the network side.

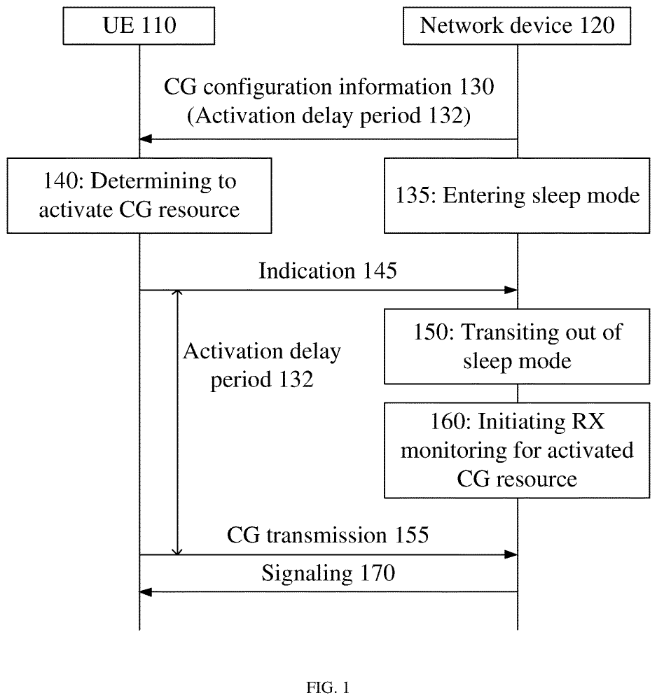

FIG. 1 to FIG. 3 shows exemplary sequence diagrams for CG activation according to various example embodiments of the present disclosure. Referring to the FIG. 1 to the FIG. 3, a UE 110 may represent any terminal device in a wireless communication network, and a network device 120 may function as a base station (BS), e.g. a next generation node-B (gNB), in the wireless communication network and serve the UE 110 as a serving cell.

Referring to the FIG. 1 to the FIG. 3, the network device 120 may transmit configuration information 130 of a CG resource to the UE 110. The configuration information 130 may be configured by the network device 120, alternatively the network device 120 may receive the configuration information 130 from other network device(s). The CG resource may comprise, for example, the CG PUSCH resource(s). Moreover, the CG resource may be of a type different from the CG Type-1 and the CG Type-2, and the type of the CG resource may be denoted as, for example, CG Type-3. In the various example embodiments, the CG resource may be activated by the UE side, e.g. the UE 110. The configuration information 130 may be transmitted to the UE 110 via e.g. a RRC signaling.

After transmitting the configuration information 130, in an operation 135 the network device 120 may enter into a sleep mode, e.g., discontinuous transmission (DTX), such that power consumption on the network device 120 may be saved.

On the UE side, with the configuration information 130 of the CG resource, in an operation 140, the UE 110 may determine to activate the CG resource. For example, if the UE 110 needs PUSCH resources to perform an uplink transmission, in the operation 140, the UE 110 may determine to activate the CG resource. In an embodiment, the UE 110 may determine to activate the CG resource in a case of reporting a non-empty BSR, which may indicate that there are data in the buffer to be transmitted. In the present disclosure, the CG resource may be a collective term and may refer to one or more CG resources, similarly, the transmission using the CG resource may also be a collective term and may refer to one or more transmissions over the CG resource(s).

As an option, then, the UE 110 may transmit to the network device 120, an indication 145 indicative of activating the CG resource. For example, the network device 120 may receive the indication 145 via at least one of the following: a dedicated scheduling request (SR), a dedicated random access (RA) preamble, dedicated uplink control information (UCI), or a PUSCH.

The dedicated SR, the dedicated RA preamble, and the dedicated UCI may be e.g. a layer 1 (L1) signaling. In an embodiment, the UE 110 may be explicitly configured, e.g. via the configuration information 130, whether the CG resource with shorter periodicity, e.g. the CG Type-3 resource, can be autonomously activated by other UL transmission(s) with longer periodicity. The CG with longer periodicity may be for example, the CG Type-1 PUSCH or the CG Type-2 PUSCH. The CG Type-3 resource can be autonomously activated by the UE 110 based on the other UL transmission(s).

For example, the PUSCH carrying the indication 145 may be a CG PUSCH with periodicity longer than that of the CG resource being activated. The CG PUSCH carrying the indication 145 may be of for example the CG Type-1 or the CG Type-2. In this case, if the network device 120 does not receive uplink transmission on the CG PUSCH with less frequent resources such as the CG Type-1 PUSCH or the CG Type-2 PUSCH, the network device 120 may sleep until the next CG PUSCH with the infrequent resources. When the network device 120 receives the uplink transmission on the CG PUSCH with less frequent resources, such as the CG Type-1 PUSCH or the CG Type-2 PUSCH, the network device 120 may begin to listen to the CG resource which is activated by the UE 110 and is more frequent, which may be, for example, the CG Type-3 resource. Thus, the resources not yet activated may be allocated to other UEs before the UE 110 starts to use them. This allows to keep a minimum level of reception at the network side, thus saving energy, and increase the level of reception upon presence of uplink data. As an option, if the buffer of the UE 110 is emptied after the transmission over the CG PUSCH with the infrequent resources, the network device 120, without receiving the non-empty BSR, may enter into the sleep mode until the next CG PUSCH with the infrequent resources.

In an embodiment, in the operation 140, the UE 110 may determine to activate at least one occasion for using the CG resource. The at least one occasion may be for example one or more consecutive CG PUSCH occasions e.g. for a defined time or a number of occasions. In this case the indication 145 may include the defined time or the number of occasions. Alternatively, the time or the number of the occasions may also be configured by the network device 120. After the at least one occasion for using the CG resource, the CG resource may be implicitly deactivated.

Alternatively, in an embodiment, after the operation 140 in which the UE 110 determines to activate the CG resource, the UE 110 will use the activated CG resource before receiving a signaling 170 explicitly deactivating the CG resource from the network device 120. In this case, the UE 110 may stop the transmission to the network device 120 using the activated CG resource in case of receiving from the network device 120, the signaling 170 deactivating the CG resource.

In an embodiment, the UE 110 can be configured, e.g. via the configuration information 130, on whether the UE 110 is allowed to directly start to use the activated CG resource after sending the indication 145 or whether the UE 110 needs a response from the network device 120 before using the activated CG resource.

In an embodiment, the UE 110 is allowed to directly start to use the activated CG resource after sending the indication 145. In this embodiment, the UE 110 may perform a transmission 155 to the network device 120 using the activated CG resource after transmitting the indication 145 without a response from the network device 120 to confirm the activation. As is shown in the FIG. 1, the UE 110 may perform the transmission 155 to the network device 120 using the activated CG resource without the response from the network device 120.

In an embodiment, the UE 110 may perform the transmission 155 using the activated CG resource without transmitting the indication 145. The transmission 155 itself may implicitly indicate that the CG resource is activated.

In an embodiment, the UE 110 may perform the transmission 155 to the network device 120 after an activation delay period 132 starting from transmitting the indication 145. For example, it is possible that the network device 120 may need a period to be ready to receive the transmission 155. For example, if the network device 120 enters into the sleep mode in the operation 135, in an operation 150, the network device 120 may transit out of the sleep mode upon receiving the indication 145.

The activation delay period 132 may be predefined in a specification or a standard. Alternatively, the network device 120 may configure the activation delay period 132 to ensure that there is sufficient time for the network device 120 to wake up for receiving the transmission 155 over the activated CG resource. For example, the network device 120 may configure the activation delay period 132 according to different sleep levels or sleep states of the network device 120. Longer activation delay period 132 may be configured for deeper sleep states that require longer transition time duration. In this case, the activation delay period 132 may be included in the configuration information 130. The activation delay period 132 starts from the timing the UE 110 transmits the indication 145, and after the activation delay period 132, the transmission 155 on the activated CG resource may be allowed.

Alternatively, the activation delay period 132 may be determined by the UE 110 based on a predefined condition. In an embodiment, the predefined condition may be associated with periodicity of at least one of the following: a synchronization signal block (SSB) or a reference signal (RS). For example, if the network device 120 changes the periodicity of other signals, such as the SSB, the RS, etc., to be longer, the UE 110 may determine the activation delay period 132 to be longer.

In an embodiment, an initial occasion for the transmission 155 using the configured grant resource may be after the activation delay period 132. For example, the UE 110 may determine the initial occasion for the transmission 155 to be after the activation delay period 132 such that the unnecessary transmission 155 may be avoided.

On the network side, in an operation 160, the network device 120 may initiate reception monitoring for the activated CG resource. As is shown in the FIG. 1, the network device 120 may perform the operation 160 after transiting out of the sleep mode in the operation 150. If the network device 120 does not perform the operation 135 to enter into the sleep mode, the network device 120 may perform the operation 160 after receiving the indication 145.

In some example embodiments, the UE 110 may perform the transmission on the activated CG resource on first one or more occasions for the activated CG resource, but may not utilize further resources until receiving a response confirming the activation indication 145.

For example, referring to the FIG. 3, the transmission 155 in the FIG. 1 may be divided into a transmission 355 and a transmission 365. The transmission 355 may be for example, performed on the first one or more occasions for the activated CG resource without a confirmation for the activation indication 145. In this case, the network device 120 may initiate reception monitoring for the activated CG resource after transiting out of the sleep mode in the operation 150. If the network device 120 does not perform the operation 135 to enter into the sleep mode, the network device 120 may perform the operation 160 after receiving the indication 145. The transmission 365 may be for example, performed on the occasions for the activated CG resource after receiving a first response 360 confirming the activation for the transmission 365 using the CG resource after the first one or more occasions.

In this embodiment, the UE 110 may perform the transmission 355 using the activated CG resource without transmitting the indication 145. The transmission 355 itself may implicitly indicate that the CG resource is activated.

In an embodiment, the UE 110 may refrain from performing the transmission 365 if without receiving the first response 360 during a first confirmation period. The first confirmation period may start from performing the transmission 355. The first confirmation period may be predefined in a specification or a standard or configured by the network deice 120.

In an embodiment, whether the first response 360 is required for the transmission 365 using the CG resource after the first one or more occasions may be predefined in a specification or a standard. Alternatively, whether the first response 360 is required for the transmission 365 using the CG resource after the first one or more occasions may be configured by the network device 120. For example, the configuration information 130 may comprise a confirmation indicator 332 to indicate the UE 110 whether the first response 360 is required for the transmission 365. The number of the first one or more occasions may also be predefined in a specification or a standard. Alternatively, the number of the first one or more occasions may also be configured by the network device 120. For example, the confirmation indicator 332 may also indicate the number of the first one or more occasions.

On the network side, in a case where the first response 360 confirming the activation is required for the transmission 365 using the CG resource after the first one or more occasions, the network device 120 may transmit to the UE 110, the first response 360 in case of confirming the activation. The operation of confirming the activation may be performed in the operation 160.

In some example embodiments, the UE 110 needs a response from the network device 120 before using the activated CG resource. For example, the UE 110 may perform the transmission on the activated CG resource after receiving a response confirming the activation indication 145.

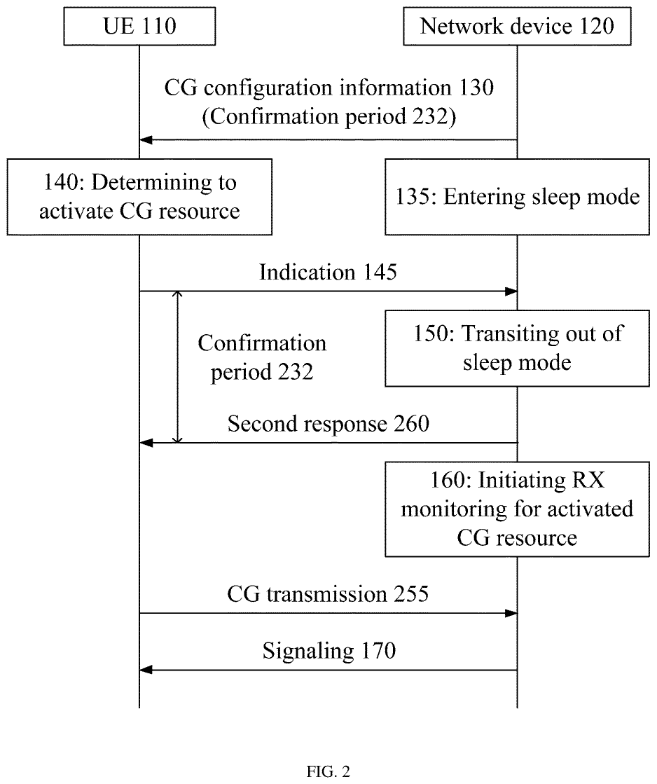

For example, referring to the FIG. 2, in response to the indication 145, the network device 120 may transmit to the UE 110, a second response 260 in case of confirming the activation. In this case, the operation 160 to initiate the reception monitoring for the activated CG resource may be performed upon transmitting the second response 260. In an embodiment, the network device 120 may trigger the activation confirmation in the operation 150. The UE 110 may perform a transmission 255 to the network device 120 using the activated CG resource after receiving the second response 260 confirming the activation.

In an embodiment, whether the second response 260 is required for the transmission 255 using the CG resource may be predefined in a specification or a standard. Alternatively, whether the second response 260 is required for the transmission 255 using the CG resource may be configured by the network device 120.

In an embodiment, the network device 120 may transmit the second response 260 after a delay period which starts from receiving the indication 145. The delay period may be predefined in a specification or a standard. Alternatively, the delay period may be configured by the network device 120. For example, the network device 120 may configure a relaxed delay period to allow enough time to exit the sleep mode, e.g. a current efficient DTX state, such that the network device 120 may complete the confirmation of the activation of the CG resource during the delay period.

As an option, the network device 120 may transmit the delay period to the UE 110 such that the UE 110 may estimate the timing for starting to receive the second response. The UE 110 may monitor the second response 260 after the delay period starting from transmitting the indication 145. For example, the configuration information 130 may include the delay period. In this case, the delay period may also be used as an indication that the second response 260 is required for the transmission 255 using the CG resource.

In an embodiment, the UE 110 may refrain from performing the transmission 255 if without receiving the second response 260 during a confirmation period 232. The confirmation period may start from transmitting the indication 145. The confirmation period 232 may be predefined in a specification or a standard or configured by the network deice 120.

As an option, the network device 120 may transmit the confirmation period 232 to the UE 110 such that the UE 110 may estimate the timing for receiving the second response. The UE 110 may monitor the second response 260 during the confirmation period 232 starting from transmitting the indication 145. For example, the configuration information 130 may include the confirmation period 232. In this case, the confirmation period 232 may also be used as an indication that the second response 260 is required for the transmission 255 using the CG resource.

In an embodiment, if the UE 110 can use the CG resource after receiving the second response 260 e.g. via PDCCH DCI, the L1 signaling indicating activation, e.g. the indication 145 may be based on the UL buffer status so that the right resource block (RB)/MCS may be activated. For example, the indication 145 may indicate an uplink buffer status, so that the second response 260 may indicate at least one of the following: at least one RB or a MCS. Based on the uplink buffer status of the UE 110, the proper RB(s) as well as MCS may be determined by the network device 120 and indicated to the UE 110.

In an embodiment, the network device 120 may use downlink feedback information (DFI) for the CG PUSCH e.g. CG DFI to carry the first response 360 or the second response 260 Although the various example embodiments of the present disclosure are described in terms of the FIG. 1 to the FIG. 3, it may be appreciated that the operations and the elements in different figures can combined unless obviously contradicting each other. For example, the transmission 355 may be performed by the UE 110 after receiving the second response 260.

According to the various example embodiments of the present disclosure, the CG resource may be activated by the UE. The network side may increase reception monitoring upon presence of uplink data or receiving the indication 145, such that a low level of reception monitoring may be performed at the network side, thus the power may be saved at the network side.

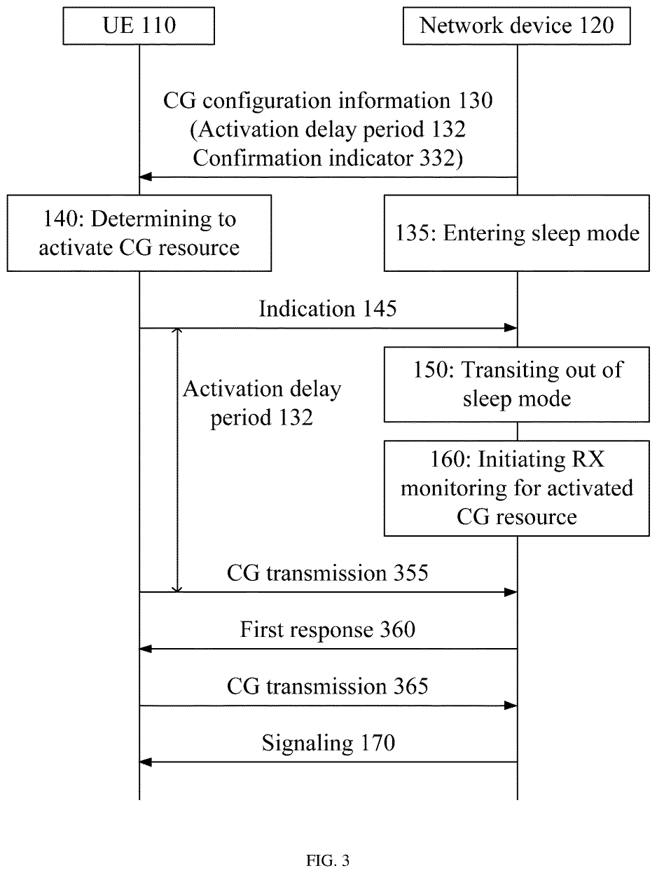

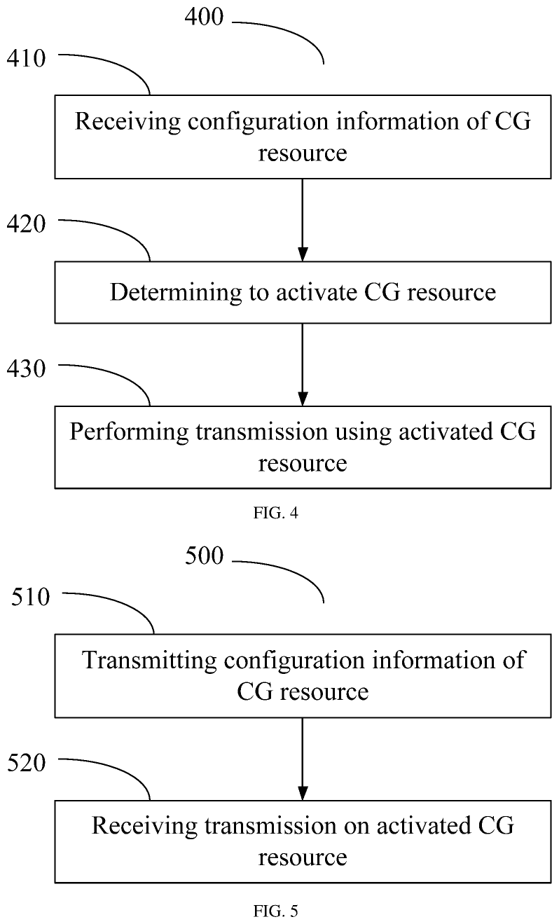

FIG. 4 shows a flow chart illustrating an example method 400 for CG activation according to the example embodiments of the present disclosure. The example method 400 may be performed for example by a terminal device such as the UE 110.

Referring to the FIG. 4, the example method 400 may include an operation 410 of receiving from a network device, configuration information of a CG resource; an operation 420 of determining to activate the CG resource; and an operation 430 of performing a transmission to the network device using the activated CG resource.

Details of the operation 410 have been described in the above descriptions with respect to at least the configuration information 130, and repetitive descriptions thereof are omitted here.

Details of the operation 420 have been described in the above descriptions with respect to at least the operation 140, and repetitive descriptions thereof are omitted here.

Details of the operation 430 have been described in the above descriptions with respect to at least the transmission 155, the transmission 255, the transmission 355, and the transmission 365, and repetitive descriptions thereof are omitted here.

In an embodiment, at least one occasion for using the CG resource may be determined to be activated. The more details have been described in the above descriptions with respect to at least the operation 140, and repetitive descriptions thereof are omitted here.

In an embodiment, the example method 400 may further include an operation of stopping the transmission to the network device using the activated CG resource in case of receiving from the network device, a signaling deactivating the CG resource. The more details have been described in the above descriptions with respect to at least the signaling 170, and repetitive descriptions thereof are omitted here.

In an embodiment, in a case where a first response confirming the activation is required for the transmission using the CG resource after first one or more occasions, the transmission after the first one or more occasions may be performed after receiving the first response. The more details have been described in the above descriptions with respect to at least the first response 360 and the transmission 365, and repetitive descriptions thereof are omitted here.

In an embodiment, the example method 400 may further include an operation of transmitting to the network device, an indication indicative of activating the CG resource. The more details have been described in the above descriptions with respect to at least the indication 145, and repetitive descriptions thereof are omitted here.

In an embodiment, the transmission to the network device may be performed after receiving a second response to the indication, the second response confirming the activation. The more details have been described in the above descriptions with respect to at least the second response 260 and the transmission 255, and repetitive descriptions thereof are omitted here.

In an embodiment, the indication may indicate an uplink buffer status. The more details have been described in the above descriptions with respect to at least the indication 145, and repetitive descriptions thereof are omitted here.

In an embodiment, the transmission to the network device may be performed after an activation delay period starting from transmitting the indication. The more details have been described in the above descriptions with respect to at least the activation delay period 132, and repetitive descriptions thereof are omitted here.

In an embodiment, the configuration information may comprise the activation delay period. The more details have been described in the above descriptions with respect to at least the configuration information 130 and the activation delay period 132, and repetitive descriptions thereof are omitted here.

In an embodiment, the activation delay period may be determined by the terminal device based on a predefined condition. The more details have been described in the above descriptions with respect to at least the activation delay period 132, and repetitive descriptions thereof are omitted here.

In an embodiment, the predefined condition may be associated with periodicity of at least one of the following: a SSB or a RS. The more details have been described in the above descriptions with respect to at least the activation delay period 132, and repetitive descriptions thereof are omitted here.

In an embodiment, an initial occasion for the transmission using the CG resource may be after the activation delay period. The more details have been described in the above descriptions with respect to at least the activation delay period 132, and repetitive descriptions thereof are omitted here.

In an embodiment, the indication may be transmitted via at least one of the following: a dedicated SR, a dedicated RA preamble, dedicated UCI, or a PUSCH. The more details have been described in the above descriptions with respect to at least the indication 145, and repetitive descriptions thereof are omitted here.

In an embodiment, the PUSCH may be a CG PUSCH with periodicity longer than that of the CG resource. The more details have been described in the above descriptions with respect to at least the CG Type-1, the CG Type-2, and the CG Type-3, and repetitive descriptions thereof are omitted here.

In an embodiment, the CG resource may be determined to be activated in a case of reporting a non-empty BSR. The more details have been described in the above descriptions with respect to at least the operation 140, and repetitive descriptions thereof are omitted here.

FIG. 5 shows a flow chart illustrating an example method 500 for CG activation according to the example embodiments of the present disclosure. The example method 500 may be performed for example by a network device such as the network device 120.

Referring to the FIG. 5, the example method 500 may include an operation 510 of transmitting to a terminal device, configuration information of a CG resource; and an operation 520 of receiving a transmission from the terminal device on the activated CG resource.

Details of the operation 510 have been described in the above descriptions with respect to at least the configuration information 130, and repetitive descriptions thereof are omitted here.

Details of the operation 520 have been described in the above descriptions with respect to at least the transmission 155, the transmission 255, the transmission 355, and the transmission 365, and repetitive descriptions thereof are omitted here.

In an embodiment, the example method 500 may further include an operation of transmitting to the terminal device, a signaling deactivating the CG resource. The more details have been described in the above descriptions with respect to at least the signaling 170, and repetitive descriptions thereof are omitted here.

In an embodiment, in a case where a first response confirming the activation is required for the transmission using the CG resource after first one or more occasions, the example method 500 may further include an operation of transmitting to the terminal device, the first response in case of confirming the activation. The more details have been described in the above descriptions with respect to at least the first response 360 and the transmission 365, and repetitive descriptions thereof are omitted here.

In an embodiment, the example method 500 may further include an operation of receiving from the terminal device, an indication indicative of activating the CG resource. The more details have been described in the above descriptions with respect to at least the indication 145, and repetitive descriptions thereof are omitted here.

In an embodiment, the example method 500 may further include an operation of initiating reception monitoring for the activated CG resource after transiting out of a sleep mode or after receiving the indication. The more details have been described in the above descriptions with respect to at least the operation 160, and repetitive descriptions thereof are omitted here.

In an embodiment, the example method 500 may further include an operation of transmitting to the terminal device, a second response to the indication for confirming the activation, in case of confirming the activation; and an operation of initiating reception monitoring for the activated CG resource upon transmitting the second response. The more details have been described in the above descriptions with respect to at least the second response 260, and the operation 160, and repetitive descriptions thereof are omitted here.

In an embodiment, the indication may indicate an uplink buffer status. The more details have been described in the above descriptions with respect to at least the indication 145, and repetitive descriptions thereof are omitted here.

In an embodiment, the configuration information may comprise an activation delay period starting from transmitting the indication, after which the transmission on the activated CG resource is allowed. The more details have been described in the above descriptions with respect to at least the activation delay period 132, and repetitive descriptions thereof are omitted here.

In an embodiment, the example method 500 may further include an operation of transiting out of a sleep mode upon receiving the indication. The more details have been described in the above descriptions with respect to at least the operation 150, and repetitive descriptions thereof are omitted here.

In an embodiment, the indication may be received via at least one of the following: a dedicated SR, a dedicated RA preamble, dedicated UCI, or a PUSCH. The more details have been described in the above descriptions with respect to at least the indication 145, and repetitive descriptions thereof are omitted here.

In an embodiment, the PUSCH may be a CG PUSCH with periodicity longer than that of the CG resource. The more details have been described in the above descriptions with respect to at least the CG Type-1, the CG Type-2, and the CG Type-3, and repetitive descriptions thereof are omitted here.

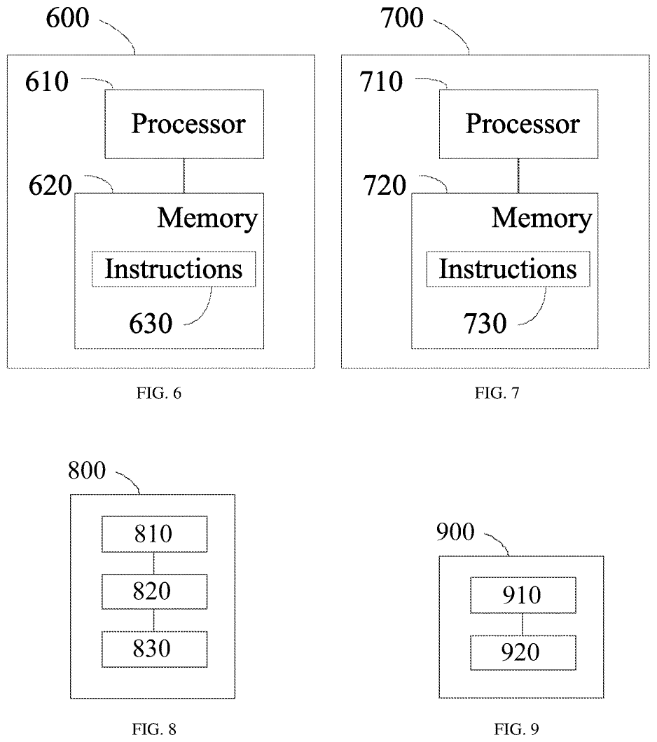

FIG. 6 shows a block diagram illustrating an example device 600 for CG activation according to the example embodiments of the present disclosure. The device, for example, may be at least part of a terminal device such as the UE 110 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 600.

FIG. 7 shows a block diagram illustrating an example device 700 for CG activation according to the example embodiments of the present disclosure. The device, for example, may be at least part of a network device such as the network device 120 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 500 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 120 is not limited to the above example device 700.

FIG. 8 shows a block diagram illustrating an example apparatus 800 for CG activation according to the example embodiments of the present disclosure. The apparatus, for example, may be at least part of a terminal device such as the UE 110 in the above examples.

As shown in FIG. 8, the example apparatus 800 may include means 810 for performing the operation 410 of the example method 400, means 820 for performing the operation 420 of the example method 400, and means 830 for performing the operation 430 of the example method 400. In one or more another example embodiments, at least one I/O interface, at least one antenna element, and the like may also be included in the example apparatus 800.

In an embodiment, at least one occasion for using the CG resource may be determined to be activated.

In an embodiment, the example apparatus 800 may further include means for performing an operation of stopping the transmission to the network device using the activated CG resource in case of receiving from the network device, a signaling deactivating the CG resource.

In an embodiment, in a case where a first response confirming the activation is required for the transmission using the CG resource after first one or more occasions, the transmission after the first one or more occasions may be performed after receiving the first response.

In an embodiment, the example apparatus 800 may further include means for transmitting to the network device, an indication indicative of activating the CG resource.

In an embodiment, the transmission to the network device may be performed after receiving a second response to the indication, the second response confirming the activation.

In an embodiment, the indication may indicate an uplink buffer status.

In an embodiment, the transmission to the network device may be performed after an activation delay period starting from transmitting the indication.

In an embodiment, the configuration information may comprise the activation delay period.

In an embodiment, the activation delay period may be determined by the terminal device based on a predefined condition.

In an embodiment, the predefined condition may be associated with periodicity of at least one of the following: a SSB or a RS.

In an embodiment, an initial occasion for the transmission using the CG resource may be after the activation delay period.

In an embodiment, the indication may be transmitted via at least one of the following: a dedicated SR, a dedicated RA preamble, dedicated UCI, or a PUSCH.

In an embodiment, the PUSCH may be a CG PUSCH with periodicity longer than that of the CG resource.

In an embodiment, the CG resource may be determined to be activated in a case of reporting a non-empty BSR.

In some example embodiments, examples of means in the example apparatus 800 may include circuitries. For example, an example of means 810 may include a circuitry configured to perform the operation 410 of the example method 400, an example of means 820 may include a circuitry configured to perform the operation 420 of the example method 400, and an example of means 830 may include a circuitry configured to perform the operation 430 of the example method 400.

The example apparatus 800 may further include means comprising circuitry configured to perform the example method 400. In some example embodiments, examples of means may also include software modules and any other suitable function entities.

FIG. 9 shows a block diagram illustrating an example apparatus 900 for CG activation according to the example embodiments of the present disclosure. The apparatus, for example, may be at least part of a network device such as the network device 120 in the above examples.

As shown in FIG. 9, the example apparatus 900 may include means 910 for performing the operation 510 of the example method 500, and means 920 for performing the operation 520 of the example method 500. In one or more another example embodiments, at least one I/O interface, at least one antenna element, and the like may also be included in the example apparatus 900.

In an embodiment, the example apparatus 900 may further include means for performing an operation of transmitting to the terminal device, a signaling deactivating the CG resource.

In an embodiment, in a case where a first response confirming the activation is required for the transmission using the CG resource after first one or more occasions, the example apparatus 900 may further include means for performing an operation of transmitting to the terminal device, the first response in case of confirming the activation.

In an embodiment, the example apparatus 900 may further include means for receiving from the terminal device, an indication indicative of activating the CG resource.

In an embodiment, the example apparatus 900 may further include means for performing an operation of initiating reception monitoring for the activated CG resource after transiting out of a sleep mode or after receiving the indication.

In an embodiment, the example apparatus 900 may further include means for performing an operation of transmitting to the terminal device, a second response to the indication for confirming the activation, in case of confirming the activation; and means for performing an operation of initiating reception monitoring for the activated CG resource upon transmitting the second response.

In an embodiment, the indication may indicate an uplink buffer status.

In an embodiment, the configuration information may comprise an activation delay period starting from transmitting the indication, after which the transmission on the activated CG resource is allowed.

In an embodiment, the example apparatus 900 may further include means for performing an operation of transiting out of a sleep mode upon receiving the indication.

In an embodiment, the indication may be received via at least one of the following: a dedicated SR, a dedicated RA preamble, dedicated UCI, or a PUSCH.

In an embodiment, the PUSCH may be a CG PUSCH with periodicity longer than that of the CG resource.

In some example embodiments, examples of means in the example apparatus 900 may include circuitries. For example, an example of means 910 may include a circuitry configured to perform the operation 510 of the example method 500, and an example of means 920 may include a circuitry configured to perform the operation 520 of the example method 500. In some example embodiments, examples of means may also include software modules and any other suitable function entities.

The example apparatus 900 may further include means comprising circuitry configured to perform the example method 500. In some example embodiments, examples of means may also include software modules and any other suitable function entities.

The example embodiments of the present disclosure also provide a computer readable medium comprising program instructions that, when executed by a terminal device such as the UE 110 in the above examples, may cause the terminal device at least to perform: receiving from a network device, configuration information of a CG resource; determining to activate the CG resource; and performing a transmission to the network device using the activated CG resource.

In an embodiment, at least one occasion for using the CG resource may be determined to be activated.

In an embodiment, the computer readable medium may further include instructions that, when executed by the terminal device, may cause the terminal device to further perform: stopping the transmission to the network device using the activated CG resource in case of receiving from the network device, a signaling deactivating the CG resource.

In an embodiment, in a case where a first response confirming the activation is required for the transmission using the CG resource after first one or more occasions, the transmission after the first one or more occasions may be performed after receiving the first response.

In an embodiment, the computer readable medium may further include instructions that, when executed by the terminal device, may cause the terminal device to further perform: transmitting to the network device, an indication indicative of activating the CG resource.

In an embodiment, the transmission to the network device may be performed after receiving a second response to the indication, the second response confirming the activation.

In an embodiment, the indication may indicate an uplink buffer status.

In an embodiment, the transmission to the network device may be performed after an activation delay period starting from transmitting the indication.

In an embodiment, the configuration information may comprise the activation delay period.

In an embodiment, the activation delay period may be determined by the terminal device based on a predefined condition.

In an embodiment, the predefined condition may be associated with periodicity of at least one of the following: a SSB or a RS.

In an embodiment, an initial occasion for the transmission using the CG resource may be after the activation delay period.

In an embodiment, the indication may be transmitted via at least one of the following: a dedicated SR, a dedicated RA preamble, dedicated UCI, or a PUSCH.

In an embodiment, the PUSCH may be a CG PUSCH with periodicity longer than that of the CG resource.

In an embodiment, the CG resource may be determined to be activated in a case of reporting a non-empty BSR.

The example embodiments of the present disclosure also provide a computer readable medium comprising program instructions that, when executed by a network device such as the network device 120 in the above examples, may cause the network device at least to perform: transmitting to a terminal device, configuration information of a CG resource; and receiving a transmission from the terminal device on the activated CG resource.

In an embodiment, the computer readable medium may further include instructions that, when executed by the network device, may cause the network device to further perform: transmitting to the terminal device, a signaling deactivating the CG resource.

In an embodiment, in a case where a first response confirming the activation is required for the transmission using the CG resource after first one or more occasions, the computer readable medium may further include instructions that, when executed by the network device, may cause the network device to further perform: transmitting to the terminal device, the first response in case of confirming the activation.

In an embodiment, the computer readable medium may further include instructions that, when executed by the network device, may cause the network device to further perform: receiving from the terminal device, an indication indicative of activating the CG resource.

In an embodiment, the computer readable medium may further include instructions that, when executed by the network device, may cause the network device to further perform: initiating reception monitoring for the activated CG resource after transiting out of a sleep mode or after receiving the indication.

In an embodiment, the computer readable medium may further include instructions that, when executed by the network device, may cause the network device to further perform: transmitting to the terminal device, a second response to the indication for confirming the activation, in case of confirming the activation; and initiating reception monitoring for the activated CG resource upon transmitting the second response.

In an embodiment, the indication may indicate an uplink buffer status.

In an embodiment, the configuration information may comprise an activation delay period starting from transmitting the indication, after which the transmission on the activated CG resource is allowed.

In an embodiment, the computer readable medium may further include instructions that, when executed by the network device, may cause the network device to further perform: transiting out of a sleep mode upon receiving the indication.

In an embodiment, the indication may be received via at least one of the following: a dedicated SR, a dedicated RA preamble, dedicated UCI, or a PUSCH.

In an embodiment, the PUSCH may be a CG PUSCH with periodicity longer than that of the CG resource.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program or instructions which may cause an apparatus to perform at least respective methods described above. Another example embodiment may be related to a computer readable medium having such computer program or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BS base station
BSR buffer status report
CG configured grant
CS-RNTI configured scheduling radio network temporary identifier
DCI downlink control information
DFI downlink feedback information
DTX discontinuous transmission
gNB next generation node-B
L1 layer 1
MCS modulation and coding scheme
PDCCH physical downlink control channel
PRB physical resource block
PUSCH physical uplink shared channel
RA random access
RB resource block
RRC radio resource control
RS reference signal
RX reception
SR scheduling request
SSB synchronization signal block
UCI uplink control information
UE user equipment

1-60. (canceled)

61. A terminal device, comprising:
at least one processor; and
at least one memory storing instructions that, when executed by the at least one processor, cause the terminal device at least to perform:
receiving from a network device, configuration information of a configured grant resource;
determining to activate the configured grant resource; and
performing a transmission to the network device using the activated configured grant resource.

62. The terminal device of claim 61, wherein at least one occasion for using the configured grant resource is determined to be activated.

63. The terminal device of claim 61, wherein the instructions, when executed by the at least one processor, cause the terminal device to further perform:
stopping the transmission to the network device using the activated configured grant resource in case of receiving from the network device, a signaling deactivating the configured grant resource.

64. The terminal device of claim 61, wherein in a case where a first response confirming the activation is required for the transmission using the configured grant resource after first one or more occasions, the transmission after the first one or more occasions is performed after receiving the first response.

65. The terminal device of claim 61, wherein the instructions, when executed by the at least one processor, cause the terminal device to further perform:
transmitting to the network device, an indication indicative of activating the configured grant resource.

66. The terminal device of claim 65, wherein the transmission to the network device is performed after receiving a second response to the indication, the second response confirming the activation.

67. The terminal device of claim 65, wherein the indication indicates an uplink buffer status.

68. The terminal device of claim 65, wherein the transmission to the network device is performed after an activation delay period starting from transmitting the indication.

69. The terminal device of claim 68, wherein the activation delay period is comprised in the configuration information, or is determined by the terminal device based on a predefined condition.

70. The terminal device of claim 69, wherein the predefined condition is associated with periodicity of at least one of the following: a synchronization signal block or a reference signal.

71. The terminal device of claim 68, wherein an initial occasion for the transmission using the configured grant resource is after the activation delay period.

72. The terminal device of claim 65, wherein the indication is transmitted via at least one of the following: a dedicated scheduling request, a dedicated random access preamble, dedicated uplink control information, or a physical uplink shared channel.

73. The terminal device of claim 72, wherein the physical uplink shared channel is a configured grant physical uplink shared channel with periodicity longer than that of the configured grant resource.

74. The terminal device of claim 61, wherein the configured grant resource is determined to be activated in a case of reporting a non-empty buffer status report.

75. A network device, comprising:
at least one processor; and
at least one memory storing instructions that, when executed by the at least one processor, cause the network device at least to perform:
transmitting to a terminal device, configuration information of a configured grant resource; and
receiving a transmission from the terminal device on the activated configured grant resource.

76. The network device of claim 75, wherein the instructions, when executed by the at least one processor, cause the network device to further perform:
transmitting to the terminal device, a signaling deactivating the configured grant resource.

77. The network device of claim 75, wherein in a case where a first response confirming the activation is required for the transmission using the configured grant resource after first one or more occasions, the instructions, when executed by the at least one processor, cause the network device to further perform:
transmitting to the terminal device, the first response in case of confirming the activation.

78. The network device of claim 75, wherein the instructions, when executed by the at least one processor, cause the network device to further perform:
receiving from the terminal device, an indication indicative of activating the configured grant resource.

79. The network device of claim 78, wherein the instructions, when executed by the at least one processor, cause the network device to further perform:
initiating reception monitoring for the activated configured grant resource after transiting out of a sleep mode or after receiving the indication.

80. A method performed by a terminal device, comprising:
receiving from a network device, configuration information of a configured grant resource;
determining to activate the configured grant resource; and
performing a transmission to the network device using the activated configured grant resource.
